(19) United States
(12) Patent Application Publication
(10) Pub. No.: US 2008/0147356 A1
(43) Pub. Date: Jun. 19, 2008

(54) Apparatus and Method for Sensing Inappropriate Operational Behavior by Way of an Array of Acoustical Sensors

(76) Inventors: Frank L. Leard, Sudbury, MA (US); Hassan R. Manjunath, Nashua, NH (US)

Correspondence Address: ROCKWELL AUTOMATION, INC. / WHD;ATTENTION: SUSAN M. DONAHUE, PATENT DEPT. / E-7F19, 1201 SOUTH SECOND STREET, MILWAUKEE, WI, 53204, US

(21) Appl. No.: 11/956,908

(22) Filed: Dec. 14, 2007

Related U.S. Application Data
(60) Provisional application No. 60/870,030, filed on Dec. 14, 2006.

(51) Int. Cl. G06F 15/00; G01H 17/00

(52) U.S. Cl. 702/183; 73/587

(57) ABSTRACT

An apparatus and method for detecting behavior of one or more pieces of equipment of a system within a facility are disclosed. In at least one embodiment, the apparatus includes an array of acoustic sensors respectively positioned at a variety of respective locations within the facility, where each of the respective acoustic sensors detects respective sounds arriving at the respective sensor from the system, including the piece of equipment. The apparatus further includes a processing device coupled to the acoustic sensors of the array, where the processing device monitors sonic information provided by the acoustic sensors in response to the sounds detected by the acoustic sensors, and detects inappropriate behavior of the piece of equipment based upon the monitored sonic information.

### CROSS-REFERENCE TO RELATED APPLICATIONS

This application claims the benefit of U.S. provisional patent application No. 60/870,030 entitled “Apparatus And Method For Sensing Inappropriate Operational Behavior By Way Of An Array Of Acoustical Sensors” filed on Dec. 14, 2006, which is hereby incorporated by reference herein.

### STATEMENT REGARDING FEDERALLY SPONSORED RESEARCH OR DEVELOPMENT

--

### FIELD OF THE INVENTION

The present invention relates to apparatuses and methods for monitoring the operation of devices and systems, for example, devices and systems employed in manufacturing or packaging processes.

### BACKGROUND OF THE INVENTION

In various facilities, such as manufacturing, packaging, warehousing, and other processing facilities (e.g., at the Post Office), there are many (e.g., hundreds) of pieces of equipment that perform a variety of features. Often, the operations within such facilities are dependent upon the proper operation of each (or at least the substantial majority) of the many pieces of equipment, and so it is desirable that all of those pieces of equipment be maintained and that failures be addressed rapidly and, preferably, before they even occur.

Yet the maintenance of many such pieces of equipment in such facilities can be a difficult task. In many conventional facilities, testing of the operability of various pieces of equipment is performed by human technicians. For example, an employee such as a technician or even a supervisor may walk around a facility with infrared (IR) imaging scope to determine whether different pieces of equipment are operating. Such an IR imaging scope is available, for example, from Edmund Scientific of Tonawanda, N.Y.

Use of such techniques and devices is inadequate on several counts. First, it requires a human being to walk around the facility. Second, conventional testing equipment such as the above-mentioned IR imaging scope typically is only able to detect that a given piece of equipment is already in failure mode and may have already begun to fail, such that there is a potential of fore-shortening other equipment that is coupled to it.

It therefore would be advantageous if there was developed an improved apparatus and/or method of sensing the operational status of multiple devices or systems in facilities. It further would be advantageous if, in at least some embodiments, such an improved apparatus/method was not as labor intensive as many conventional methods. Also, it would be advantageous if, in at least some embodiments, such an improved apparatus/method was able to detect that pieces of equipment were likely to fail prior to such failures actually occurring.

### BRIEF SUMMARY OF THE INVENTION

The present inventor has recognized than many pieces of equipment in facilities such as those described above make distinctive sounds when they are operating, and those sounds change in observable manners in various circumstances, for example, when the pieces of equipment are no longer operating properly or are about to experience a failure. The present inventor has further recognized that, at least in some circumstances, it would be possible by way of one or more acoustic sensors to detect such sound changes and determine that a piece of equipment was experiencing a failure or about to experience a failure. The present inventor has further recognized that, where many pieces of equipment are employed in a large facility, an array of such acoustic sensors positioned at various locations around the facility can serve to determine the occurrence of failures, or imminence of failures, of numerous pieces of equipment situated around the facility. More particularly, in at least some embodiments, the signals received by the array of acoustic sensors can be used to monitor an overall symphony of noise signals from various pieces of equipment, so as to allow for the detection of inappropriate sounds indicative of failure or imminent failure (e.g., noises or noise trends). Also in at least some embodiments, a triangulation process is implemented by which sound information detected by differently-positioned acoustic sensors allows for sounds from different pieces of equipment to be distinguished from one another.

More particularly, in at least some embodiments, the present invention relates to an apparatus for detecting inappropriate behavior of a piece of equipment of a system within a facility. The apparatus includes an array of acoustic sensors respectively positioned at a variety of respective locations within the facility, where each of the respective acoustic sensors detects respective sounds arriving at the respective sensor from the system, including the piece of equipment. The apparatus further includes a processing device coupled to the acoustic sensors of the array, where the processing device monitors sonic information provided by the acoustic sensors in response to the sounds detected by the acoustic sensors, and detects the inappropriate behavior of the piece of equipment based upon the monitored sonic information.

Further, in at least some embodiments, the present invention relates to an apparatus for monitoring changes in a piece of equipment. The apparatus includes at least one acoustical sensor located within proximity of the piece of equipment, for receiving at least one sound input therefrom, and a processing device in communication with the at least one acoustical sensor such that the at least one sound input can be monitored as a sound signature by the processing device. The processing device communicates with a catalog of sound signatures and performs a comparison of the monitored sound signature with at least one of the catalogued sound signatures, the catalog including sound signatures from at least one of a properly functioning piece of equipment and an improperly functioning piece of equipment. Also, the processing device further performs an additional action upon determining that a change has occurred in the piece of equipment based upon the comparison.

Additionally, in at least some embodiments, the present invention relates to a method for detecting inappropriate behavior of a piece of equipment of a system within a facility. The method includes positioning an array of acoustic sensors at a variety of respective locations within the facility, and detecting sound information produced by the system including the piece of equipment with the acoustic sensors. The method further includes processing at least some of the detected sound information at a processing device, wherein the processing includes comparing at least a portion of the detected sound information with stored sound signature information and, based upon the comparing, determining if the inappropriate behavior of the piece of equipment has occurred. The method also includes taking a further action upon the determining, the further action including at least one of sending a signal to a user indicative of the inappropriate behavior, sending a message to a logging device regarding the inappropriate behavior, causing a shutdown of at least a part of the system, and generating an additional command.

### BRIEF DESCRIPTION OF THE DRAWINGS

FIG. 1 shows an exemplary facility in which there are several pieces of equipment, an array of acoustic sensors for sensing the sounds produced by the pieces of equipment, and a processing device for processing the sound information and determining based upon that sound information whether one or more of the pieces of equipment are experiencing a failure or are potentially about to experience a failure;

FIGS. 2A and 2B respectively are first and second graphs showing exemplary sounds (more particularly, frequency spectra) produced by one of the pieces of equipment within the facility of FIG. 1, as sensed by two of the acoustic sensors of the array of FIG. 1 at first and second times, respectively; and

FIGS. 3A-3C are additional graphs showing exemplary sounds (frequency spectra), with FIG. 3A more particularly showing exemplary sounds produced by both first and second pieces of equipment within the facility of FIG. 1 as sensed by two of the acoustic sensors of the array of FIG. 1, and FIGS. 3B and 3C respectively showing components of the sounds shown in FIG. 3A that are attributable to the first and second pieces of equipment, respectively.

### DETAILED DESCRIPTION OF THE PREFERRED EMBODIMENT

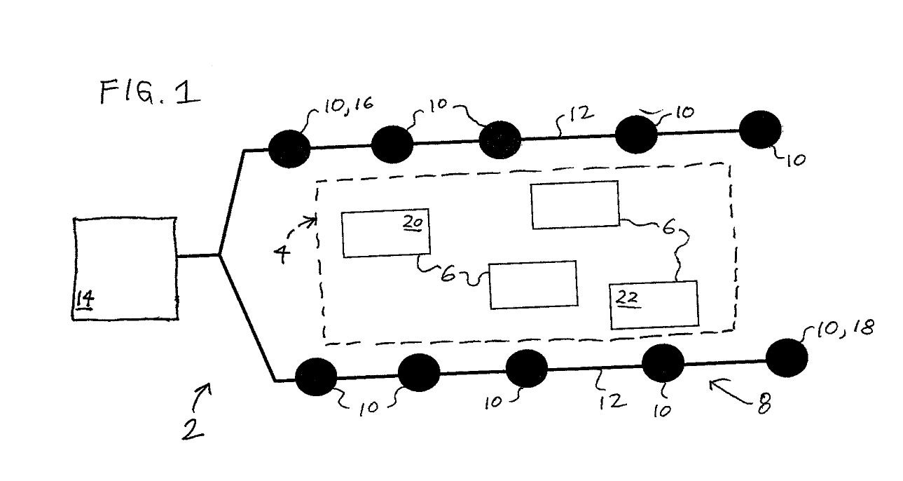

Referring to FIG. 1, an exemplary facility 2 having a system 4 including multiple pieces of equipment 6 is shown. In the present embodiment, the system 4 is a conveyor system and the facility 2 is a processing facility such as a Post Office letter processing facility. However, in alternate embodiments, the present invention can pertain to a variety of other types of systems employed in a variety of other types of facilities including, for example, manufacturing facilities, packaging facilities, warehousing facilities, and other types of processing facilities.

Also in the present embodiment, the multiple pieces of equipment 6 include four pieces of equipment, each of which can be a motor for causing movement of the conveyor system 4. Typically, these pieces of equipment are arranged at various different locations within the facility 2, e.g., at different points along the assembly line. In alternate embodiments, the multiple pieces of equipment 6 can include any other number of pieces of equipment (e.g., less than four pieces of equipment, or more or many more than four pieces of equipment) and the pieces of equipment can be spaced at different locations in any of a variety of different manners. Also, the pieces of equipment can be any of a variety of different types of motors, generators, or other types of mechanical or electromechanical equipment (or even other types of equipment), some or all of which generate sounds/noises while operating (or even when inoperative).

Further as shown, in the present embodiment, the facility 2 also includes a sensing net or array 8 formed from multiple acoustic transducers or sensors 10 that are linked to one another by way of one or more wired connections 12 that are strung together in a daisy-chain manner. In the present embodiment, the sensing array 8 includes ten of the sensors 10 linked together by way of the connections 12. In other embodiments, the number of acoustic sensors can be any arbitrary number (in particular, the number of sensors need not be exactly the same number of sensors as there are pieces of equipment 6) albeit, typically, there are at least more than one acoustic sensor in the sensing array 8. Also, notwithstanding the present manner of connecting the sensors 10, in alternate embodiments the sensors can be connected in a manner other than a daisy-chain, and/or one or more of the connections can be wireless connections. Also, depending upon the embodiment, the connections can involve any of a variety of networking techniques or protocols.

The multiple acoustic sensors 10 are respectively positioned at different respective locations within the facility 2, and operate to sense the added (superposed) sound signatures from the pieces of equipment 6 of the system 4. More particularly, in the present embodiment, the various acoustic sensors 10 are arranged so as to extend around the system 4, albeit other arrangements are possible as well (e.g., extending alongside the system, etc.). Because the different sensors 10 are positioned at different geographic locations relative to the pieces of equipment 6 of the system 4, the sounds received by the different sensors from the different pieces of equipment vary depending upon the sensor. In particular, the overall sound signature detected at any given sensor differs from those detected at the other sensors due to variations in the relative amplitudes of the different signal components, which occur due to differences in attenuation and/or reflection of the respective sound waves traveling to each respective sensor. As discussed further below, through a triangulation process made possible by the varying geographic locations of the different sensors 10 and resulting variations in the signal components received by the different sensors, distinct signal components within the received sounds that are attributable to particular ones of the pieces of equipment can be identified and analyzed.

In at least some embodiments, particular respective ones of the sensors 10 are located near respective ones of the pieces of equipment 6 so that the sounds associated with each piece of equipment are picked up particularly well at least by one of the sensors. However, in other embodiments such as that illustrated by FIG. 1, the acoustic sensors 10 need not be particularly situated adjacent any of the pieces of equipment. The sensing array 8 even when designed in such a manner (where sensors are not particularly situated by particular pieces of equipment) can still be valuable insofar as the each of the different sensors at the different positions (e.g. due to differences in attenuation and reflection of the sounds within the facility, etc.) still tends to pick up different sounds than those picked up by the other sensors, and consequently an overall analysis of all of the sound signals picked up by the sensors can provide useful information. In short, by stringing or otherwise coupling together the series of acoustic sensors 10 in an array fashion among the equipment 6 along the floor of (or otherwise within) the facility 2, numerous different sounds can be sensed in a manner that potentially allows for the particular sounds attributable to any given piece of equipment 6 to be detected and analyzed.

In order to process and analyze the sensed sound information provided by the sensors 10, the sensors 10 are not only connected to one another but also are then connected to a processing device or computer 14. Depending upon the embodiment, the computer 14 can take a variety of forms and, for example, can be a personal computer having, in addition to processing circuitry (e.g., a microprocessor), input/output devices such as a display, a keyboard and a mouse, as well as one or more memory devices. The computer 14 also in some embodiments can be connected to other computerized devices or other devices by way of, for example, networks such as the Internet or World Wide Web (which can involve, among other things, wired or wireless communications).

The computer system 14 is capable of performing one or more of a variety of different monitoring, processing and analytical operations, and in some embodiments is also capable of causing actions to occur based upon the results of such monitoring, processing and analysis. In the present embodiment, the computer system 14 in particular receives and monitors the acoustical spectrum of the system 4 (and its pieces of equipment 6) as sensed by the different sensors 10 over time. The computer 14 stores in its memory (or otherwise has available to it) various sound characteristic information indicative of normal and/or abnormal sonic characteristics of various pieces of equipment/machinery. Further, often (if not always) the computer system 14 will store (or otherwise have available to it) position information regarding the positioning of the different sensors 10 in relation to one another (and/or possibly information regarding the relative positioning of the pieces of equipment 6 of the system, in relation to one another and/or in relation to the sensors 10).

By comparing the sensed sound information from the different sensors 10, the computer system 14 is able to triangulate and determine which components of the sound information come from which geographic location and thus from which particular piece of equipment 6. Further, by comparing the sensed sound information with the stored sound characteristic information, the computer 14 is also able to determine whether one or more of the pieces of equipment 6 are present and operational, and/or whether such piece(s) of equipment are experiencing a failure or about to experience a failure. For example, an imminent failure of a motorized piece of equipment can be detected by identifying (e.g., by way of triangulation) and monitoring those signal components which are attributable to that piece of equipment, and then further determining when a change in the characteristic sonic frequency or spectrum of sonic frequencies emitted by that piece of equipment has occurred (e.g., by comparing the sensed frequency information to a stored frequency characteristic associated with that piece of equipment). Based upon when such a change in the sonic output of that piece of equipment occurs, the computer 14 can thus determine when that piece of machinery has begun (or will begin) to decline or stop working (or whether, indeed, the piece of machinery has stopped working or failed).

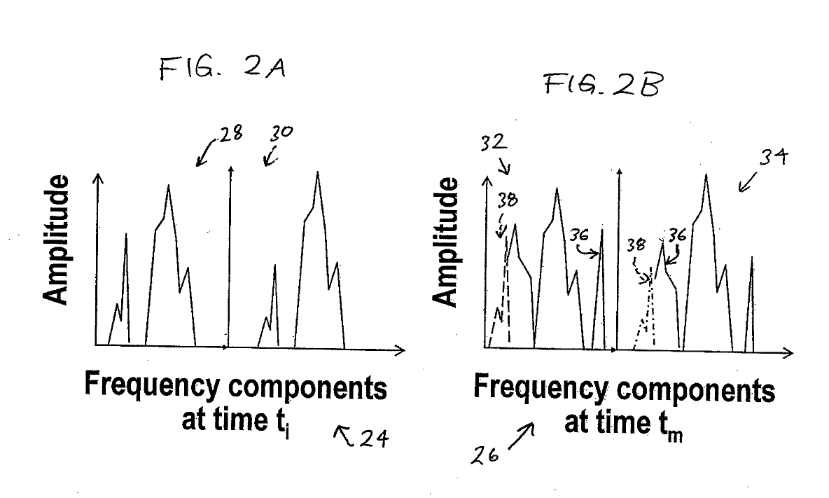

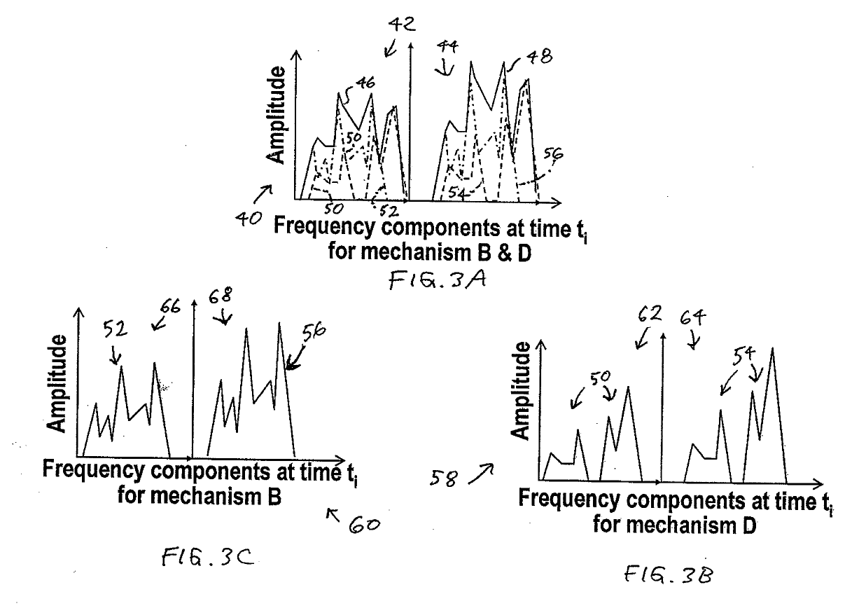

Referring to FIGS. 2A-2B and 3A-3C, graphs are provided showing exemplary frequency spectra that can be received at different ones of the acoustic sensors 10 and processed by the computer 14 as described above. With respect to FIGS. 2A and 2B, first and second graphs 24 and 26 show exemplary frequency spectra received at two different times tᵢ and tₘ, respectively, by two of the sensors 10 of FIG. 1, where the frequency spectra in particular correspond to sounds emanating from a first one of the pieces of equipment 20 of FIG. 1. More particularly, FIG. 2A shows in first and second sections 28 and 30, respectively, that the frequency spectra received at a first, leftmost one of the sensors 16 differ in their amplitude levels from those received at a second, rightmost one of the sensors 18, due to the different geographical locations of those sensors relative to the piece of equipment 20. Although in this example it appears that certain frequency components have higher amplitudes in section 28 and others have higher amplitudes in section 30, in other circumstances it can also be the case that all frequency components will be of higher amplitude in one of the sections than the other.

As for FIG. 2B, the graph 26 shows in first and second sections 32 and 34, respectively, how the frequency spectra received by the two sensors 16 and 18, respectively, can potentially have changed between the time tᵢ and the time tₘ. In particular, new frequency components 36 have emerged that did not exist at the time tᵢ. Also, several frequency components 38 that existed at the time tᵢ may or may not still be present depending upon the example (those components are shown with dashed lines, indicating that depending upon the circumstance one or both of those components may or may not be present). FIGS. 2A and 2B thus illustrate that, to the extent that the computer 14 has available to it characteristic information indicating that the frequency spectra shown in the graph 24 are indicative of “normal” or “healthy” operation by the piece of equipment 20, the computer 14 upon reviewing the information shown in the graph 26 is able to determine based upon a comparison of that information with the characteristic information that the piece of equipment is either failing or about to experience a failure. More particularly, if the computer 14 determines that a failure is imminent, the computer 14 can further take a preventative action, such as causing the system 4 to be shut down or sending a message to an operator requesting that preventative maintenance be performed.

As discussed above, typically multiple pieces of equipment will be present and operating in a system being monitored, and thus the sounds/noises sensed by the sensors 10 will be a “symphony” of sound signature components that are respectively attributable to the different pieces of equipment. Although it can be generally assumed that the frequency spectra corresponding to different pieces of equipment do not generally cancel one another out or otherwise interfere, but rather that the frequency spectra are simply additive, the presence of frequency spectra from multiple pieces of equipment still will obscure the frequency spectra associated with any given piece of equipment. Assuming this to be the case, in order to analyze the sound signature of any given piece of equipment in the manner illustrated by FIGS. 2A-2B, the computer 14 not only needs to be able to detect when the sound signature of a given piece of equipment varies, but also to needs to be able to differentiate/distinguish between the sound components from the different pieces of equipment. FIGS. 3A-3C illustrate this process of separating out specific sound components from an overall symphony of sound signatures.

More particularly, FIG. 3A is a graph 40 having first and second sections 42 and 44 that respectively illustrate such a symphony of sound signatures, as sensed by the first and second sensors 16 and 18, respectively, at the time tᵢ. In this example, overall symphonies of sound signatures represented respectively by solid lines 46 and 48 in the sections 42 and 44, respectively, are due to the addition (superposition) of first and second sets of sound components represented by dashed lines 50, 54 and 52, 56, respectively, which are produced by the first piece of equipment 20 of the system 4 of FIG. 1 and a second of the pieces of equipment 22 of that system. FIGS. 3B and 3C illustrate how the computer 14, in order to analyze the performance of any given piece of equipment, distinguishes the sound components attributable to that given piece of equipment from those attributable to other pieces of equipment. More particularly, FIG. 3B shows a graph 58 having first and second sections 62 and 64 that respectively show the first sets of sound components 50 and 54 produced by the first piece of equipment 20, as sensed at the time tᵢ by the first and second sensors 16 and 18, respectively. Alternatively, FIG. 3C shows a graph 60 having first and second sections 66 and 68 that respectively show the second sets of sound components 52 and 56 produced by the second piece of equipment 22, as sensed at the time tᵢ by the first and second sensors 16 and 18, respectively.

The process illustrated by FIGS. 3A-3C in at least some circumstances involves triangulation, in which the signals received at two or more of the acoustic sensors 10 are compared with one another in order to determine portions of the symphony of sound signatures that are due to different pieces of equipment. Various algorithms and techniques can be implemented to compare the different sound signature information obtained by the different acoustic sensors to allow attribution of certain signal components to a particular piece of equipment. For example, although not always the case, often the intensity of a given signal component received at a given sensor will be stronger at that sensor if the originating piece of equipment is closer to that sensor rather than farther from that sensor. Consequently, by comparing the overall sound signature information obtained from two different sensors at two different locations, those components which are stronger at one of the sensors and weaker at another of the sensors can rightly be attributed to a device that is closer to the one sensor rather than the other sensor.

The process of separating out sound components attributable to particular pieces of equipment also often involves use of the characteristic information already available to the computer 14. That is, to identify the sound components attributable to a particular piece of equipment, it is often useful to compare characteristic information with portions those components of the symphony of sound signatures that vary depending upon the receiving sensor. Further, to the extent that position information regarding the locations of the acoustic sensors and/or the pieces of equipment is available, that information additionally can enable the computer 14 to rapidly determine associations between particular sound components and particular pieces of equipment, and allow for the separating out of desired sound components attributable to a particular piece of equipment from the remaining sound components.

Although it is possible that some characteristic information regarding characteristic sound components of particular pieces of equipment can be standardized information that pertains generically to a given type of equipment regardless of many or any particular circumstances in which it is implemented, in other circumstances the characteristic information of a given piece of equipment can vary widely depending upon its manner of implementation, its operational circumstances, or the facility within which it is employed (among other factors). For example, a motor employed in a conveyor system can emit sounds from its bearings that vary depending upon whether the motor is under load or not. In such cases, the characteristic information available to the computer can include sound recordings that are obtained once the piece of equipment has been installed and operated in a given facility (e.g., once the motor is being operated in the conveyor system, both under load and not under load).

In still additional embodiments, the computer 14 need not compare the sensed sonic information with stored sonic information, but rather can perform calculations or algorithm-based analysis upon the received sonic information and detect failures or imminent failures based upon such calculations/analysis. In further embodiments, detection can be accomplished both based upon algorithms/calculations and comparisons with known sonic data, or by way of other techniques. In at least some embodiments, the computer 14 monitors the overall symphony of sounds received from all of the acoustic sensors 10 and is able to detect failures or imminent failures when the acoustic symphony becomes increasingly an acoustic cacophony.

It should be evident from the above that, in at least some embodiments, the computer 14 is capable of not only detecting a failure or imminent failure, but also is able to automatically determine the identity of the particular piece or pieces of equipment that are malfunctioning or about to experience a malfunction/failure. Such detection information can be provided to technicians or operators in a variety of ways (e.g., by way of a video terminal or other output device) so that the technicians/operators can address the issue(s) with the particular piece(s) of equipment. Further, in some embodiments, a complete or partial diagnosis of the problem with a given piece of equipment can also be determined by the computer 14. Additionally, in some embodiments, an operator can input information to the computer 14 by way of an input device (e.g., a keyboard) allowing or facilitating the computer's determination of a failure.

Still in further embodiments, the computer 14 is able to automatically take actions, or cause other machines/computers to take actions, in response to detecting that a malfunction/failure has or is about to occur. For example, in at least some embodiments, signals can be communicated to the malfunctioning machine to shut down its operation, or an entire system (e.g., the conveyor system 4) could be shut down. Also, in at least some embodiments, the computer 14 communicates sensed failure information or other information with various other computers and other devices or systems that may be within the facility 2 or remotely located (e.g., at a remote monitoring facility), by way of any of a variety of wired or wireless networks or communication links including, for example, the internet. For example, a single operator or user could monitor (and/or control) the operation of multiple differently-located facilities remotely from a single monitoring station.

It is specifically intended that the present invention not be limited to the embodiments and illustrations contained herein, but include modified forms of those embodiments including portions of the embodiments and combinations of elements of different embodiments as come within the scope of the following claims.

We claim:

1. An apparatus for detecting inappropriate behavior of a piece of equipment of a system within a facility, the apparatus comprising:
an array of acoustic sensors respectively positioned at a variety of respective locations within the facility, wherein each of the respective acoustic sensors detects respective sounds arriving at the respective sensor from the system, including the piece of equipment; and
a processing device coupled to the acoustic sensors of the array, wherein the processing device monitors sonic information provided by the acoustic sensors in response to the sounds detected by the acoustic sensors, and detects the inappropriate behavior of the piece of equipment based upon the monitored sonic information.

2. The apparatus of claim 1, wherein the array of acoustic sensors includes at least first and second acoustic sensors that are positioned at first and second locations that differ from one another.

3. The apparatus of claim 2, wherein the sonic information provided to the processing device includes first sonic information provided by the first acoustic sensor in response to first sounds detected by the first acoustic sensor, and also includes second sonic information provided by the second acoustic sensor in response to second sounds detected by the second acoustic sensor.

4. The apparatus of claim 3, wherein the processing device performs a triangulation operation by which the processing device calculates at least one of an identity and a position of the piece of equipment based upon the first and second sonic information.

5. The apparatus of claim 1, wherein the respective sounds received by the respective acoustic sensors are produced by the piece of equipment and at least one additional piece of equipment of the system.

6. The apparatus of claim 5, wherein the respective sounds received by the respective acoustic sensors each include a respective set of first and second sound components, and wherein the amplitude of at least one of the sound components of the set received by a first of the respective acoustic sensors differs from the amplitude of the corresponding at least one of the sound components of the set received by a second of the respective acoustic sensors.

7. The apparatus of claim 5, wherein the piece of equipment is selected from the group consisting of a motor, a generator, another electromechanical device, and another mechanical device.

8. The apparatus of claim 1, wherein the processing device is a computer that includes or is in communication with a memory device, the memory device storing information regarding at least one characteristic sound component of the piece of equipment.

9. The apparatus of claim 8, wherein the processing device identifies a portion of the monitored sonic information as being representative of specific sounds produced by the piece of equipment by comparing at least some of the monitored sonic information with the at least one characteristic sound component of the piece of equipment.

10. The apparatus of claim 8, wherein the processing device determines that the inappropriate behavior has occurred by comparing at least some of the monitored sonic information with the at least one characteristic sound component of the piece of equipment.

11. The apparatus of claim 8, wherein the at least one characteristic sound component includes at least one of a first sonic component produced by the piece of equipment when the piece of equipment is operating normally, a second sonic component produced by the piece of equipment when the piece of equipment is operating abnormally, a third sonic component produced by the piece of equipment when an additional piece of equipment is operating normally, and a fourth sonic component produced by the additional piece of equipment when the additional piece of equipment is operating abnormally.

12. The apparatus of claim 1, wherein the array of acoustical sensors includes a plurality of acoustical sensors arranged around a perimeter of the system and connected with one another and the processing device by way of at least one wireless or wired connection link.

13. The apparatus of claim 1, wherein the processing device provides at least one of a signal to an operator indicative of the inappropriate behavior and a command to a controlled device upon determining that the inappropriate behavior has occurred.

14. An apparatus for monitoring changes in a piece of equipment comprising:
at least one acoustical sensor located within proximity of the piece of equipment, for receiving at least one sound input therefrom, and
a processing device in communication with the at least one acoustical sensor such that the at least one sound input can be monitored as a sound signature by the processing device,
wherein the processing device communicates with a catalog of sound signatures and performs a comparison of the monitored sound signature with at least one of the catalogued sound signatures, the catalog including sound signatures from at least one of a properly functioning piece of equipment and an improperly functioning piece of equipment, and
wherein the processing device further performs an additional action upon determining that a change has occurred in the piece of equipment based upon the comparison.

15. The apparatus of claim 14, wherein the comparison involves a determination of whether there is an exact match or a substantial match between the monitored sound signature and the at least one catalogued sound signature.

16. The apparatus of claim 14 further including, a recording device in communication with the processing device for creating catalog entries from a monitored sound signature.

17. The apparatus of claim 14, wherein the array is situated at least partially around the piece of equipment and additional pieces of equipment, wherein the processing device receives respective sound inputs from each of the acoustical sensors in the array, and wherein the processing device performs at least one triangulation calculation to distinguish a particular sound signature of the piece of equipment apart from other sound signatures of the additional pieces of equipment.

18. The apparatus of claim 14, further comprising means for allowing a user to remotely access the processing device.

19. A method for detecting inappropriate behavior of a piece of equipment of a system within a facility, the method comprising:
positioning an array of acoustic sensors at a variety of respective locations within the facility;
detecting sound information produced by the system including the piece of equipment with the acoustic sensors;
processing at least some of the detected sound information at a processing device, wherein the processing includes comparing at least a portion of the detected sound information with stored sound signature information and, based upon the comparing, determining if the inappropriate behavior of the piece of equipment has occurred; and
taking a further action upon the determining, the further action including at least one of sending a signal to a user indicative of the inappropriate behavior, sending a message to a logging device regarding the inappropriate behavior, causing a shutdown of at least a part of the system, and generating an additional command.

20. The method of claim 19, wherein the processing includes recording and storing of the sound signature information.

21. The method of claim 19, wherein the processing includes monitoring a change in the detected sound information that occurs over time.

22. The method of claim 19, wherein the processing further includes triangulating the sound signature detected to identify specific sound signatures for different pieces of equipment of the system.

23. The method of claim 19, wherein the processing additionally includes identifying a particular sound signature from among the detected sound information.

24. The method of claim 19, wherein the processing further includes performing a calculation based upon the monitored sonic information, and determining an identity of the piece of equipment.

25. The method of claim 19, wherein the inappropriate behavior is behavior indicating that the piece of equipment is potentially about to experience a failure.
